(19) United States
(12) Patent Application Publication
(10) Pub. No.: US 2002/0158903 A1
(43) Pub. Date: Oct. 31, 2002

(54) Apparatus for outputting textual renditions of graphical data and method therefor

(75) Inventors: Janani Janakiraman, Austin, TX (US); Rabindranath Dutta, Austin, TX (US)

Correspondence Address: Kelly K. Kordzik, 5400 Renaissance Tower, 1201 Elm Street, Dallas, TX, 75270-2199, US

(73) Assignee: International Business Machines Corporation, Armonk, NY

(21) Appl. No.: 09/842,835

(22) Filed: Apr. 26, 2001

(51) Int. Cl. G09G 5/00

(52) U.S. Cl. 345/746; 345/760

(57) ABSTRACT

A system and method for providing a textual rendition of graphical information incorporated in web pages is provided. The textual rendition may be output in a format accessible to those users with visual impairments for whom graphical representation of data cannot be perceived. For example, the textual rendition may be output in audio form. Alternatively, a tactile format may be used in conjunction with a Braille display, for example. The textual rendition is generated in response to an image analysis of the graphical information from which salient features of the graphical information may be extracted.

### CROSS REFERENCE TO RELATED APPLICATIONS

The present invention is related to the following U.S. patent applications which are hereby incorporated herein by reference:

Ser. No. 09/______ , “Apparatus to Convey Depth Information in Graphical Images and Method Therefor” (Attorney Docket No. AUS9-2001-0094US1);

Ser. No. 09/______ , “Scanning and Outputting Textual Information in Web Page Images” (Attorney Docket No. AUS9-2001-0096US1); and

Ser. No. 09/______ , “Extracting Textual Equivalents of Multimedia Content Stored in Multimedia Files” (Attorney Docket No. AUS9-2001-0097US1).

### TECHNICAL FIELD

The present invention relates to the field of assisting individuals with disabilities through technology, and more particularly to rendering graphical information contained in web page images in textual form to promote accessibility to individuals with disabilities.

### BACKGROUND INFORMATION

Congress passed the “Assistive Technology Act of 1998” to promote the assistance of individuals with disabilities through technology such as encouraging the promotion of technology that will allow individuals with disabilities to partake in the information technology, e.g., Internet.

The development of computerized distribution information systems, such as the Internet, allows users to link with servers and networks, and thus retrieve vast amounts of electronic information that was previously unavailable using conventional electronic mediums. Such electronic information increasingly is replacing the more conventional means of information distribution such as newspapers, magazines and television.

Users may be linked to the Internet through a hypertext system of servers commonly referred to as the World Wide Web (WWW). With the World Wide Web, an entity having a domain name may create a “web page” or “page” that can provide information and, to some degree, some interactivity. Referring to FIG. 1A, schematically illustrating network system 100. Web server 102 may store web pages for transmission to a web client 104, via Internet 106.

A computer user may “browse”, i.e., navigate around, the WWW by utilizing a suitable web browser, e.g., Netscape Navigator™, Internet Explorer™, or a talking browse such as, Home Page Reader™ (HPR) available from International Business Machines Corp. and a network gateway, e.g., Internet Service Provider (ISP). A web browser allows the user to specify or search for a web page on the WWW and subsequently retrieve and display web pages on the user's computer screen. Such web browsers are typically installed on personal computers or workstations to provide web client services such as web client 104, but increasingly may be found on wireless devices such as cell phones.

The Internet is based upon a suite of communication protocols known as Transmission Control Protocol/Internet Protocol (TCP/IP) which sends packets of data between a host machine, e.g., server computer on the Internet commonly referred to as a web server, and a client machine, e.g., a user's computer connected to the Internet. The WWW is a network of computers that use an Internet interface protocol which is supported by the same TCP/IP transmission protocol.

A web page may typically include content in a multiplicity of media. In addition to text, these may include images, audio and video. Examples of images, may include, navigational menus, pop-up windows/menus, charts and graphs. Images, audio and video may be specified in a HyperText Markup Language (HTML) file that is sent from the web server, such as web server 102, to the client machine, such as web client 104. HTML files may be exchanged on the Internet in accordance with the HyperText Transfer Protocol (HTTP). In the HTML source code, images, video and audio may be specified in various files of different formats. For example, an image may be represented in a Graphics Interchange Format (GIF), Joint Photographic Experts Group (JPEG) and Portable Network Graphics (PNG) file format. Video may be represented in a Moving Pictures Expert Group (MPEG) file format. Audio may be represented in a MPEG Audio Player (MP3) file format. The HTML file may then be parsed by the web browser in order to display the images and graphics on the client machine.

FIG. 1B illustrates an example of such graphical information in a web page, in particular, the price of a share of IBM stock over a five day interval. Although such graphical information enables a sighted user to quickly extract salient features, such as the maximum and minimum values of the stock price over the time period depicted, the information in graphical format is inaccessible to the visually impaired user. Additionally, such graphical presentations may pose difficulties for users with perception challenges, such as dyslexia. FIG. 1B will be discussed further in conjunction with FIG. 3 hereinbelow.

Thus, there is a need in the art for systems and methods for rendering salient features of graphical information in web pages accessible to users with vision or other perception impairments.

### SUMMARY OF THE INVENTION

The aforementioned needs are addressed by the present invention. Accordingly, there is provided, in a first form, a method for presenting graphical data to a user. The method includes analyzing a set of graphical data to determine a set of critical factors present in the graphical data. The determined critical factors are ranked according to respective priorities set for each of the critical factors. A textual description of the set of graphical data is generated, wherein the textual description is ordered according to the priority of the respective critical factor.

There is also provided, in a second form, a computer program product embodied in a tangible storage medium, the program product for presenting graphical data. The program product contains a program of instructions for analyzing a set of graphical data to determine a set of critical factors present in the graphical data. Also included are instructions for ranking the determined critical factors according to respective priorities set for each of the critical factors, and generating a textual description of the set of graphical data in which the textual description is ordered according to the priority of the respective critical factor.

Additionally, there is provided, in a third form, a data processing system. The system includes circuitry operable for analyzing a set of graphical data to determine a set of critical factors present in the graphical data. Also included is circuitry operable for ranking the determined critical factors according to respective priorities set for each of the critical factors, and generating a textual description of the set of graphical data in which the textual description is ordered according to the priority of the respective critical factor.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1A illustrates a network system which may be used with the present invention;

FIG. 1B illustrates an exemplary web page having data presented in a graphical format;

FIG. 2 illustrates, in block diagram form, a data processing system implemented in accordance with the present invention;

FIG. 3 illustrates, in flow chart form, a textual rendition methodology in accordance with an embodiment of the present invention; and

FIG. 4 illustrates, in tabular form, a data set representing graphical data which may be analyzed in accordance with the embodiment of FIG. 3;

FIGS. 5A and 5B respectively illustrate, in tabular form, exemplary rendition modes and textual templates which may be used with an embodiment of the present invention in accordance with FIG. 3;

FIG. 6 illustrates, in tabular form, an exemplary set of critical factors which may be used with an embodiment of the present invention in accordance with FIG. 3;

FIG. 7, illustrates in further detail, a portion of the embodiment of the present invention in accordance with the embodiment of FIG. 3; and

FIG. 8, illustrates, in tabular form, an exemplary mapping of rendition modes and analysis operations which may be used with an embodiment of the present invention in accordance with FIG. 3.

### DETAILED DESCRIPTION

The present invention provides a system and method for providing a textual rendition of graphical information incorporated in web pages. The textual rendition may be output in a format accessible to those users with visual impairments for whom graphical representation of data cannot be perceived. For example, the textual rendition may be output in audio form. Alternatively, a tactile format may be used. The textual rendition is generated in response to an image analysis of the graphical information from which salient features of the graphical information may be extracted.

In the following description, numerous specific details are set forth such as specific graphical data to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted in as much as such details are not necessary to obtain a complete understanding of the present invention and are within the skills of persons of ordinary skill in the relevant art.

Refer now to the drawings wherein depicted elements are not necessarily shown to scale and wherein like or similar elements are designated by the same reference numeral through the several views.

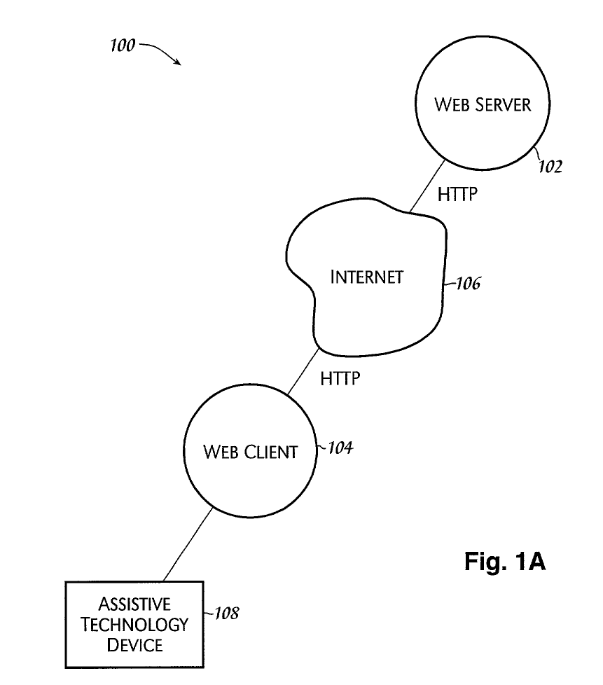

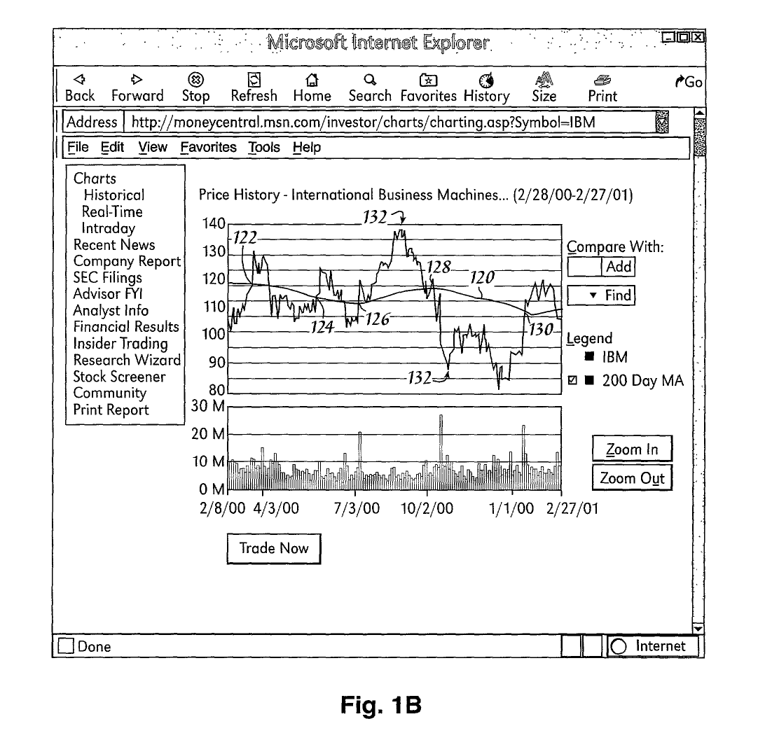

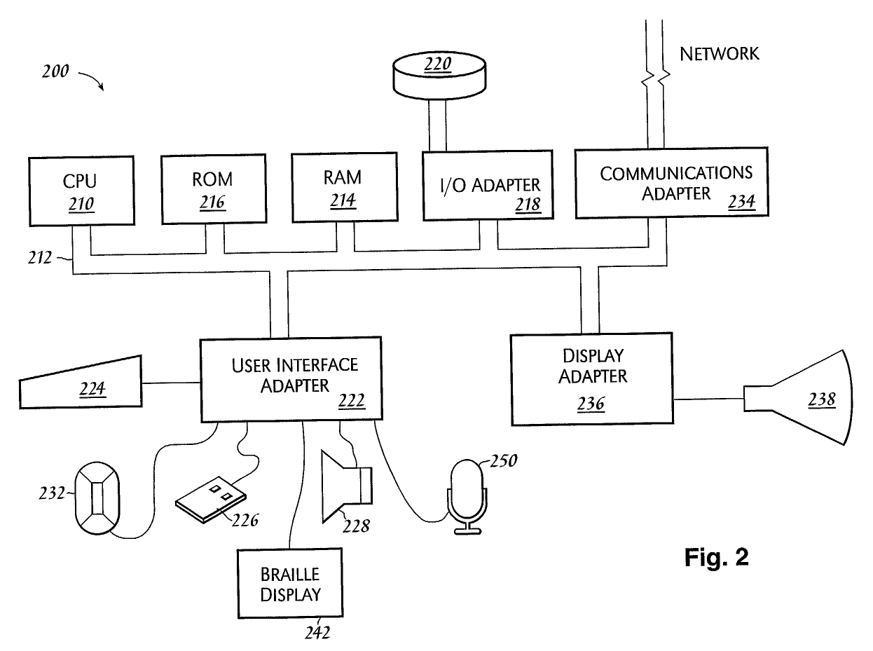

Referring first to FIG. 2, an example is shown of a data processing system 200 which may be used for the invention. System 200, may for example, be used in an embodiment of web client 104, FIG. 1A. The system has a central processing unit (CPU) 210, which is coupled to various other components by system bus 212. Read only memory (“ROM”) 216 is coupled to the system bus 212 and includes a basic input/output system (“BIOS”) that controls certain basic functions of the data processing system 200. Random access memory (“RAM”) 214, I/O adapter 218, and communications adapter 234 are also coupled to the system bus 212. I/O adapter 218 may be a small computer system interface (“SCSI”) adapter that communicates with a disk storage device 220. Communications adapter 234 interconnects bus 212 with an outside network enabling the data processing system to communicate with other such systems. Input/Output devices are also connected to system bus 212 via user interface adapter 222 and display adapter 236. Keyboard 224, track ball 232, mouse 226 and speaker 228, minophone 250 and Braille display 242 are all interconnected to bus 212 via user interface adapter 222. Display monitor 238 is connected to system bus 212 by display adapter 236. In this manner, a user is capable of inputting to the system throughout the keyboard 224, trackball 232 or mouse 226 and receiving output from the system via speaker 228, display 238 and Braille display 242.

Preferred implementations of the invention include implementations as a computer system programmed to execute the method or methods described herein, and as a computer program product. According to the computer system implementation, sets of instructions for executing the method or methods are resident in the random access memory 214 of one or more computer systems configured generally as described above. These sets of instructions in conjunction with the system components which execute them, including I/O devices such as Braille display 242 and speaker 225, may be included in assistive technology device 108, FIG. 1. Until required by the computer system, the set of instructions may be stored as a computer program product in another computer memory, for example, in disk drive 220 (which may include a removable memory such as an optical disk or floppy disk for eventual use in the disk drive 220). Further, the computer program product can also be stored at another computer and transmitted when desired to the user's work station by a network or by an external network such as the Internet. One skilled in the art would appreciate that the physical storage of the sets of instructions physically changes the medium upon which it is stored so that the medium carries computer readable information. The change may be electrical, magnetic, chemical, biological, or some other physical change. While it is convenient to describe the invention in terms of instructions, symbols, characters, or the like, the reader should remember that all of these and similar terms should be associated with the appropriate physical elements.

Note that the invention may describe terms such as comparing, validating, selecting, identifying, or other terms that could be associated with a human operator. However, for at least a number of the operations described herein which form part of at least one of the embodiments, no action by a human operator is desirable. The operations described are, in large part, machine operations processing electrical signals to generate other electrical signals.

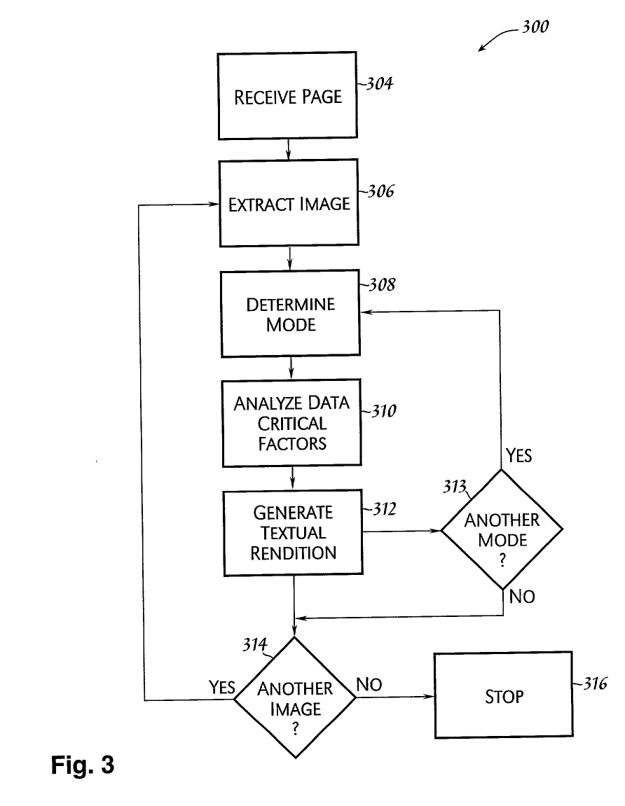

Refer now to FIG. 3 illustrating, in flow chart form, methodology 300 for a textual rendition of graphical information on a web page.

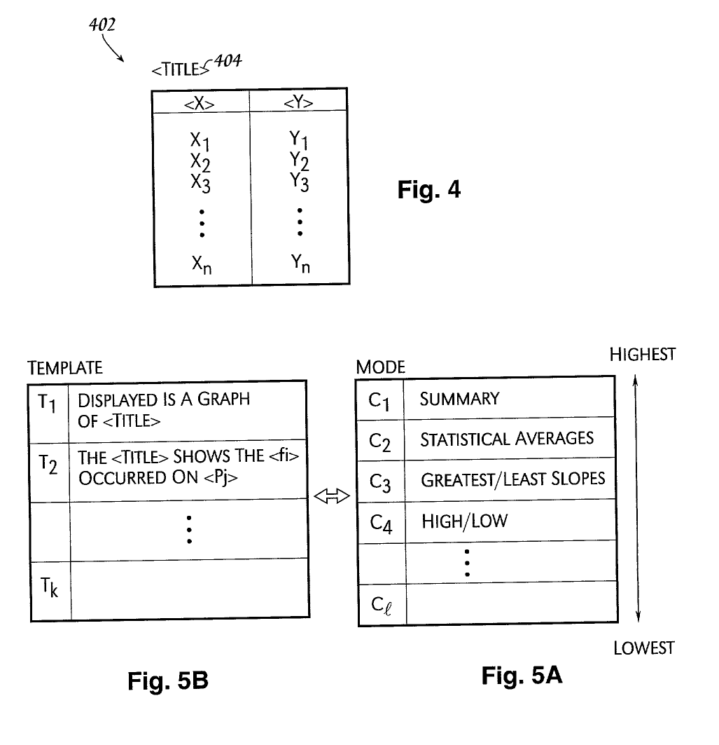

In step 304, a web page is received. A web page may be represented as a hypertext markup language (HTML) file. Graphical information in the web page may be incorporated as a table of values, such as Table 402, FIG. 4. Table 402, includes a number, n, of pairs of values, generically labeled as <X>, and <Y>. Although labeled as “X” and “Y”, it would be understood that these labels are “meta labels”, and may represent any pair of independent and dependent variables, respectively. For example, in the exemplary web page illustrated in FIG. 1B, the “Y” values are stock prices, and the “X” values represent time. Additionally, a <TITLE> 404 may be associated with the graphical data. Again, it would be understood by an artisan of ordinary skill that <TITLE> 404 denotes a “meta title” and that in a particular instance of a set of graphical data, the title associated therewith would be descriptive of the information presented. Additionally, a web page may include graphical data in the form of an image. Images may be specified in various files of different formats. For example, an image may be represented in a GIF, JPEG or PNG file formation. Typically, such an image file may be associated with a line of the HTML source file via an “IMG” tag. Note that once the graphical information has been downloaded to the client, they may be cached in RAM, for example RAM 214, FIG. 2, or alternatively, in nonvolatile storage, such as disk storage device 220, FIG. 2. If, the graphical information has been provided as an image, a table of values, as discussed in conjunction with FIG. 4, may be generated using image analysis software. Such image analysis software which may be used to create such a table includes commercially available software, for example KBVision™ from Amerinex Applied Imaging, Inc., Amherst, Mass. Other image analysis software which may be used in conjunction with the present invention is Khoros Pro™ from Khoral Research, Inc., Albuquerque, NM. Additionally, text associated with the graphical image may be extracted, for example, for the purpose of providing a title, in accordance with the principles of the invention disclosed in the co-pending commonly owned U.S. patent application entitled “Scanning and Outputting Textual Information in Web Page Images” which is hereby incorporated in its entirety herein by reference.

In step 308, a rendition mode is determined. (A rendition mode may be simply referred to as a mode hereinbelow. Additionally, rendition and description may be used interchangeably for the purposes of the present invention.) A mode determines the nature of the information to be rendered in textual form, and may be selected from a predetermined set of l modes. An exemplary set of modes is illustrated, in tabular form, in FIG. 5. The set of modes may be selected in accordance with the web server, that is, Uniform Resource Locator (URL) associated with the graphical data. As will be discussed further hereinbelow, analysis of the graphical data, such as data in table 402, FIG. 4, is associated with the rendition mode. In the exemplary of modes in FIG. 5, mode c₁ provides a textual rendition associated with a summary of the graphical data, mode c₂ is associated with statistical averages, mode C₃ is associated with the largest/least changes in the data values that is, the slope of the data, and mode C₄ is associated with high and low values in the data. As illustrated in FIG. 5, modes may be prioritized, which priority may represent an order of importance, or significance to the user.

Associated with the rendition mode, are critical factors in the underlying graphical data. Thus, for example, for a textual rendition, drawn to high and low data values, mode c₄ in the exemplary set in FIG. 5, are maxima and minima of the data over a specified interval of the independent variable. In general, depending on the set of rendition modes, a set of critical factors may be identified in the graphical data. Identification of the critical factors may be prioritized in accordance with the prioritization of the set of modes.

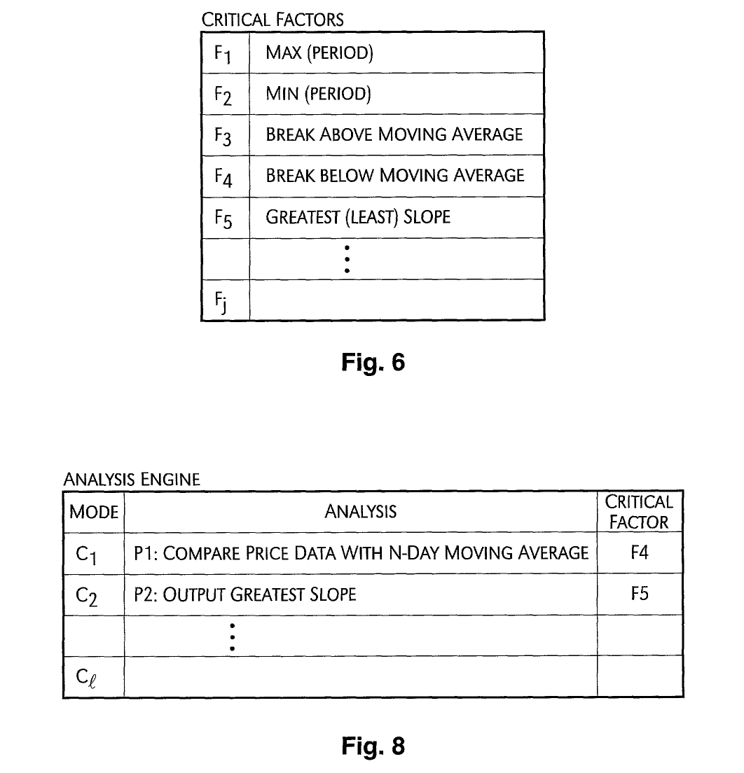

In step 310, the data is analyzed to identify the critical factors. Exemplary factors are illustrated in FIG. 6. In addition to the factors, labeled F₁ and F₂, respectively, of a maximum value over a specified interval, or period, and a minimum value over a specified interval, are factor F₃ break above moving average, F₄, break below moving average, and factor F₅ greatest/least slope. It would be understood by persons of ordinary skill in the art, that other critical factors may be included, in an embodiment of the present invention depending on the rendition modes provided therein. Such embodiments would fall within the spirit and scope of the present invention.

Step 310 may be performed by an analysis engine that performs numerical analysis of quantitative data, and which includes a set of numerical analysis routines implemented in accordance with standard algorithms, and an application program interface (API) through which the data, such as the data in table 402, FIG. 4, are passed to the analysis routines, and logic for selecting the appropriate routines in response to the rendition mode.

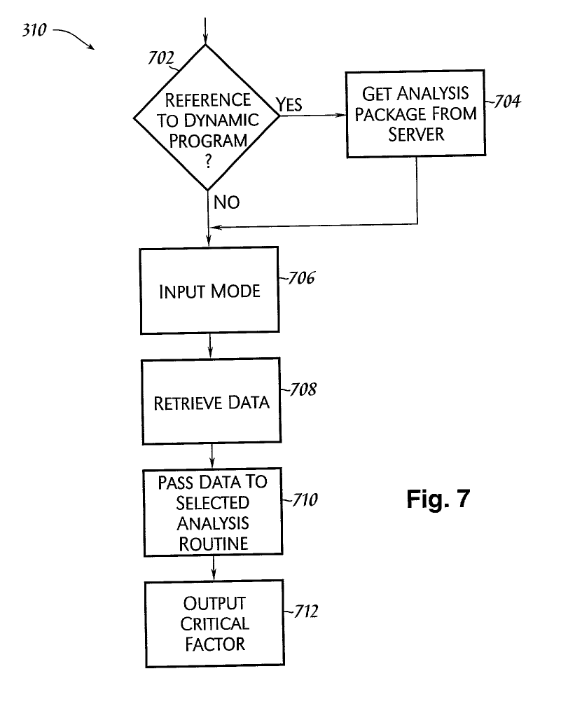

Thus, refer to FIG. 7, illustrating step 310 in further detail. In step 702, it is determined if the web page continuing the graphical information includes a reference to a dynamic program. If so, then an analysis package which may be used to analyze the graphical data may be obtained from the web page server. Note, as previously discussed, the available modes may be preselected by the web page and the analysis package may then correspond to those modes. The inclusion of a reference to a dynamic program indicates that the analysis package may be obtained from the server, and in step 704,the analysis package is retrieved from the server. The package may be provided as an ActiveX control for example. Alternatively, it may be in the form of a Java™ applet or in yet another alternative, a Javascript program. If there is no reference to a dynamic program, step 704 is bypassed, and the analysis performed using client-side software. In step 706, the mode is input to the analysis engine. In step 708, the data is retrieved, and in step 710, passed to an analysis routine selected in response to the rendition mode from step 706. The analysis engine may include a set of routines which perform an analysis operation Pᵢ associated with a mode cᵢ as illustrated, in tabular form, in FIG. 8. For a number I of modes, c₁ , . . . , cₗ there may be corresponding operations P₁ , . . . , Pₗ. Nore that an operation Pₗ may invoke one or more routines in the analysis package.

Using the illustrative graph of FIG. 1B as exemplary if the mode selected is determined, as described in conjunction with 308, FIG. 3, is statistical averages, then the critical factor may be points at which the stock price breaks above an N-day moving average, and critical factors may be identified using a standard comparison routine, comparing the prices (<Y> values) with the N-day moving average at the same points in time (<X> values), along with a determination of the slope of the price at the corresponding point. In FIG. 1B, curve 120 is a 200-day moving average of the price of IBM stock.. The critical factor for which the stock price breaks above the 200-day moving average may be identified at the points where the difference between the price and the moving average vanishes, and additionally, where the slope of the price is positive. Again an analysis routine for evaluating the slope for the set of data may be implemented using established techniques in the data processing art, for example by (piecewise) fitting the data to a polynomial, and evaluating the slope using the polynomial. Techniques for fitting such polynomials to a set of data may be found in WILLIAM H. PRESS ET AL., NUMERICAL RECIPES THE ART OF SCIENTIFIC COMPUTING 77-101 (Cambridge Univ. Press 1986). Alternatively, commercially available analysis software may be used to implement an analysis engine. One such commercial software product is Mathematica® from Wolfram Research, Inc., Champaign, Ill. In this way, in FIG. 1B, the critical factors identified are the points 122-130.

Returning to FIG. 3, in step 312, a textual rendition of the graphical data, in response to the critical factors identified in step 310, is generated. Textual renditions, which may be in an audio format for example, may be generated using a set of templates. (Alternatively, a tactile format may be generated, for example, using Braille display, such as Braille display 242, FIG. 2, however the principles of the invention to be described are not dependent on the format.) An exemplary set of templates is illustrated in FIG. 5B. Each template Tⱼ of the set of k templates includes a fixed portion of text and one or more variable portions that are passed to the template from the data itself or from the output of the analysis engine. Note that the set of templates may include simple connectives such as “and” “or” etc. (which are not shown in FIG. 5B). Additionally, a variable portion may be passed a NULL value which suppresses the output of that portion of the template to avoid repetition, for example. Thus in FIG. 5B, template T₁ takes the title of the data, denoted by the meta-title <TITLE>as an argument. For example, a textual rendition of under template T₁ of the data illustrated in FIG. 1B would generate the text “displayed is a graph of price history of IBM Feb. 28. 2000 to Feb. 27, 2001.” The set of templates effects a mapping between the modes and textual renditions as indicated by the double-headed arrow. The mapping need not be one-one. Thus, a summary mode may map to two or more templates to generate a rendition by sequentially “executing” selected templates in accordance with the mode.

Thus, by way of example, a summary mode, such as c₁ in FIG. 6, may generate a rendition “the price history International Business Machines Feb. 28, 2000 to Feb. 27, 2001 shows a 52-week high 133 occurred on Sep. 1, 2000 [132] and a 52 week low 82 occurred on Dec. 20, 2000 [134]. (The reference numerals have been indicated for illustrative purposes herein and would be understood to not be included in the textual rendition.) This may be rendered by sequentially executing template T2 twice, with a NULL passed in the <TITLE> portion in the second instance. Note that the illustrations are exemplary, and other templates may be provided in accordance with the types of information and modes implemented, and such embodiments would fall within the spirit and scope of the present invention.

In step 313. it is determined if another mode is to be rendered. This may be selected in response to user input. If so, methodology returns to step 308 to determine the mode as previously discussed. Otherwise, is step 314 it is determined if additional images are included in the page. If so, a next image is processes by returning to step 306, and if no further images are to be rendered, methodology 300 terminates in step 316.

Although the present invention and its advantages have been described in detail, it should be understood that various changes, substitutions and alterations can be made herein without departing from the spirit and scope of the invention as defined by the appended claims.

What is claimed is:

1. A method for presenting graphical data to a user, comprising the steps of:
analyzing a set of graphical data to determine a set of critical factors present in the graphical data;
ranking the determined critical factors according to respective priorities set for each of the critical factors; and
generating a textual description of the set of graphical data, ordered according to the priority of the respective critical factor.

2. The method as recited in claim 1, wherein the set of critical factors and the textual description are selected according to a selected mode.

3. The method as recited in claim 2, wherein the mode is selected according to a URL associated with the set of graphical data.

4. The method of claim 1 wherein said step of generating said textual description further comprises the step of generating said textual rendition in an aural format.

5. The method of claim 1 wherein said step of generating said textual description further comprises the step of generating said textual rendition in an tactile format.

6. The method of claim 2 wherein said priority of the respective critical factor is determined in accordance with said selected mode.

7. The method of claim 1 wherein said step of generating said textual description of the set of graphical data includes generating said textual description in accordance with one or more textual templates.

8. A computer program product embodied in a tangible storage medium, the program product for presenting graphical data, the program product including a program of instructions for performing the steps of:
analyzing a set of graphical data to determine a set of critical factors present in the graphical data;
ranking the determined critical factors according to respective priorities set for each of the critical factors; and
generating a textual description of the set of graphical data, ordered according to the priority of the respective critical factor.

9. The program product of claim 8 wherein the set of critical factors and the textual description are selected according to a selected mode.

10. The program product of claim 9 wherein the mode is selected according to a URL associated with the set of graphical data.

11. The program product of claim 8 wherein said program of instruction for performing the step of generating said textual description further comprises a program of instruction for performing the step of generating said textual description in an aural format.

12. The program product of claim 8 said program of instruction for performing the step of generating said textual description comprises a program of instruction for performing the step of generating said textual description in a tactile format.

13. The program product of claim 9 wherein said priority of the respective critical factor is determined in accordance with said selected mode..

14. The program product of claim 8 wherein said step of generating said textual description of the set of graphical data includes generating said textual description in accordance with one or more textual templates.

15. A data processing system comprising:
circuitry operable for analyzing a set of graphical data to determine a set of critical factors present in the graphical data;
circuitry operable for ranking the determined critical factors according to respective priorities set for each of the critical factors; and
circuitry operable for generating a textual description of the set of graphical data, ordered according to the priority of the respective critical factor.

16. The system as recited in claim 1, wherein the set of critical factors and the textual description are selected according to a selected mode.

17. The system as recited in claim 2, wherein the mode is selected according to a URL associated with the set of graphical data.

18. The system of claim 15 wherein said circuitry operable for generating said textual description further comprises circuitry operable for generating said textual rendition in an aural format.

19. The system of claim 15 wherein said circuitry operable for generating said textual description further comprises circuitry operable for generating said textual rendition in an tactile format.

20. The system of claim 16 wherein said priority of the respective critical factor is determined in accordance with said selected mode.

21. The system of claim 15 wherein said circuitry operable for generating said textual description of the set of graphical data includes circuitry operable for generating said textual description in accordance with one or more textual templates.
